(19) United States
(12) Patent Application Publication
(10) Pub. No.: US 2025/0079928 A1
(43) Pub. Date: Mar. 6, 2025

(54) Hydrodynamic bearing, bearing assembly, and high-speed motor

(71) Applicant: Shenzhen FeiYida Motor Limited Company, Shenzhen (CN)

(72) Inventors: Jingyi Chen, Shenzhen (CN); Yunhai Xiao, Shenzhen (CN); Tongsong Wu, Shenzhen (CN)

(21) Appl. No.: 18/820,716

(22) Filed: Aug. 30, 2024

(30) Foreign Application Priority Data
Aug. 31, 2023 (CN) 202311112767.9

(51) Int. Cl. H02K 5/167; F16C 17/02; F16C 37/00; H02K 1/16

(52) U.S. Cl. CPC H02K 5/1675; F16C 17/026; F16C 37/00; H02K 1/16; F16C 2204/10; F16C 2380/26

(57) ABSTRACT

The present disclosure discloses a hydrodynamic bearing, including a cylindrical bearing main body; and a through hole provided in a center of the bearing main body in a penetrating manner; an oil storage groove is arranged in a middle part of the through hole; a plurality of oil slots are provided on upper and lower sides of an inner wall of the through hole; the oil slots are herringbone; oil leak prevention slots are respectively provided on two sides, close to end openings, of the inner wall of the through hole; and the two oil leak prevention slots are respectively communicated with the corresponding oil slots. The present disclosure further discloses a bearing assembly and a high-speed motor.

### TECHNICAL FIELD

The present disclosure relates to the technical field of bearings, and in particular, to a hydrodynamic bearing, a bearing assembly, and a high-speed motor.

### BACKGROUND

A high-speed motor is usually a motor with a speed exceeding 10000 r/min. The high-speed motor has the following advantages: Firstly, due to the high speed, the motor has a high power density, and the volume of the motor is much smaller than that of a motor with ordinary power, which can effectively save materials. Secondly, the high-speed motor can be connected to a prime mover. It eliminates a traditional speed reduction mechanism, so that the transmission efficiency is high and the noise is low. Thirdly, due to the small inertia of rotation, the high-speed motor has quick dynamic response. As one of important components in the high-speed motor, a bearing assembly generally includes a rotating shaft, a bearing sleeve, a bearing, and a magnet. However, the bearing assembly in the existing high-speed motor generally uses a mechanical bearing. Due to the high-speed rotation of the rotating shaft on the bearing, there is mechanical friction between the rotating shaft and the bearing, significant noise will be generated, and the service life of the high-speed motor is short. Therefore, a hydrodynamic bearing, a bearing assembly, and a high-speed motor are provided to solve the problems of high noise and short life during the rotation of the existing high-speed motor.

### SUMMARY

One of the objectives of the present disclosure is to provide a hydrodynamic bearing, a bearing assembly, and a high-speed motor, to solve the problems of high noise and short life during the rotation of the existing high-speed motor.

The present disclosure provides a hydrodynamic bearing, a bearing assembly, and a high-speed motor, which can be achieved by the following technical solutions:

The present disclosure discloses a hydrodynamic bearing, including a cylindrical bearing main body; and a through hole provided in a center of the bearing main body in a penetrating manner; an oil storage groove is arranged in a middle part of the through hole; a plurality of oil slots are provided on upper and lower sides of an inner wall of the through hole; the oil slots are herringbone; oil leak prevention slots are respectively provided on two sides, close to end openings, of the inner wall of the through hole; and the two oil leak prevention slots are respectively communicated with the corresponding oil slots.

In an implementation, a plurality of heat dissipation slots are provided on an outer side of the bearing main body.

In an implementation, the heat dissipation slots include transverse heat dissipation slots and longitudinal heat dissipation slots; and the transverse heat dissipation slots and the longitudinal heat dissipation slots are respectively crosswise arranged on the outer side of the bearing main body.

In an implementation, a material of the bearing main body is copper.

A bearing assembly includes the hydrodynamic bearing according to any one of the above, a rotating shaft a magnet, wherein the rotating shaft is arranged on the hydrodynamic bearing in a movably penetrating manner; the rotating shaft and the hydrodynamic bearing are connected in a non-contact manner through lubricating oil; and the magnet is fixedly arranged on the rotating shaft and drives the rotating shaft to rotate.

In an implementation, the rotating shaft includes a rotating shaft main body and a limiting column; the limiting column is arranged at a middle part of the rotating shaft main body; and the rotating shaft main body and the limiting column are integrally formed.

A high-speed motor includes the bearing assembly according to any one of the above, a motor shell, a circuit board, a stator assembly, and fan blades, wherein the motor shell is a hollow cylindrical chamber; the stator assembly is fixedly arranged in the motor shell; the circuit board is fixed on one side of the stator assembly and is electrically connected to the stator assembly; the bearing assembly is arranged on the stator assembly in a movably penetrating manner; and the fan blades are fixedly arranged at one end of the bearing assembly.

In an implementation, the stator assembly includes a stator core and a stator winding; the stator core is fixedly arranged in the motor shell; and the stator winding is arranged on the stator core.

In an implementation, a connection interface is arranged on the circuit board, and the connection interface uses a connection needle seat.

In an implementation, the motor shell is made of a metal material, and contact portions between the hydrodynamic bearing and an inner wall of the motor shell are in interference fit.

Compared with the prior art, the beneficial effects of the hydrodynamic bearing, the bearing assembly, and the high-speed motor of the present disclosures are as follows:

According to the hydrodynamic bearing, the bearing assembly, and the high-speed motor, the lubricating oil in the plurality of oil slots is driven to move through the rotating shaft. The lubricating oil is converged from two side ends of the herringbone oil slots to vertexes of the herringbone oil slots. When the lubricating oil reaches the vertexes of the herringbone oil slots, the lubricating oil forms high oil pressures at the vertexes. The rotating shaft is jacked by the several high oil pressures in the through hole, so that the rotating shaft and the hydrodynamic bearing rotate at a high speed in a non-contact manner through the action of the lubricating oil, without contact and friction between mechanical parts. This reduces the noise of the high-speed motor and reduces the wear of the components, thereby prolonging the service life of the high-speed motor and effectively solving the problem of high noise and short life of the existing high-speed motor during the rotation.

According to the hydrodynamic bearing, the bearing assembly, and the high-speed motor of the present disclosure, by the arrangement of the plurality of heat dissipation slots on the outer side of the hydrodynamic bearing, air can pass through the heat dissipation slots to perform air cooling on the hydrodynamic bearing, which can effectively reduce the temperature of the hydrodynamic bearing and prolong the service life of the hydrodynamic bearing. Meanwhile, the oil storage groove and the two oil leak prevention slots are arranged in the through hole. Some of the excess lubricating oil can be stored in the oil storage groove, which can continuously supply oil to the hydrodynamic bearing. By the use of the two oil leak prevention slots, the lubricating oil can be prevented from flowing out of the two end openings of the through hole, thereby maintaining the normal low noise of the hydrodynamic bearing and prolonging the service life of the hydrodynamic bearing.

### BRIEF DESCRIPTION OF THE DRAWINGS

For clearer descriptions of the technical solutions of the embodiments of the present disclosure, the accompanying drawings required to be used in the embodiments are briefly introduced below. It should be understood that the accompanying drawings below are only some embodiments of the present disclosure. Therefore, the embodiments shall not be regarded as limitations on the scope. A person of ordinary skill in the art can also derive other relevant drawings according to these drawings without creative work.

FIG. 1 is a schematic structural diagram of a hydrodynamic bearing according to the present disclosure;

FIG. 2 is a structural sectional view of the hydrodynamic bearing shown in FIG. 1 according to the present disclosure;

FIG. 3 is a schematic structural diagram of a bearing assembly according to the present disclosure;

FIG. 4 is a schematic diagram of an exploded structure of the bearing assembly shown in FIG. 3 according to the present disclosure;

FIG. 5 is a schematic structural diagram of a high-speed motor according to the present disclosure; and

FIG. 6 is a structural sectional view of the high-speed motor shown in FIG. 5 according to the present disclosure.

Numerals in the drawings: 10: bearing assembly; 11: hydrodynamic bearing; 111: bearing main body; 112: through hole; 1211: oil storage groove; 1212: oil slot; 1213: oil leak prevention slot; 113: heat dissipation slot; 12: rotating shaft; 121: rotating shaft main body; 122: limiting column; 13: magnet; 20: motor shell; 30: circuit board; 31: connection interface; 40: stator assembly; and 50: fan blade.

### DETAILED DESCRIPTION OF THE EMBODIMENTS

To make the objectives, technical solutions, and advantages of the embodiments of the present disclosure clearer, the technical solutions in the embodiments of the present disclosure are clearly described below with reference to the accompanying drawings in the embodiments of the present disclosure. Apparently, the described embodiments are merely some rather than all the embodiments of the present disclosure. Assemblies of the embodiments of the present disclosure commonly described and shown in the accompanying drawings here may be arranged and designed in a variety of different configurations.

Therefore, the following detailed descriptions of the embodiments of the present disclosure provided in the accompanying drawings are not intended to limit the scope of the claimed present disclosure, but merely represents selected embodiments of the present disclosure. All other embodiments obtained by a person of ordinary skill in the art based on the embodiments of present disclosure without making creative efforts shall fall within the protection scope of present disclosure.

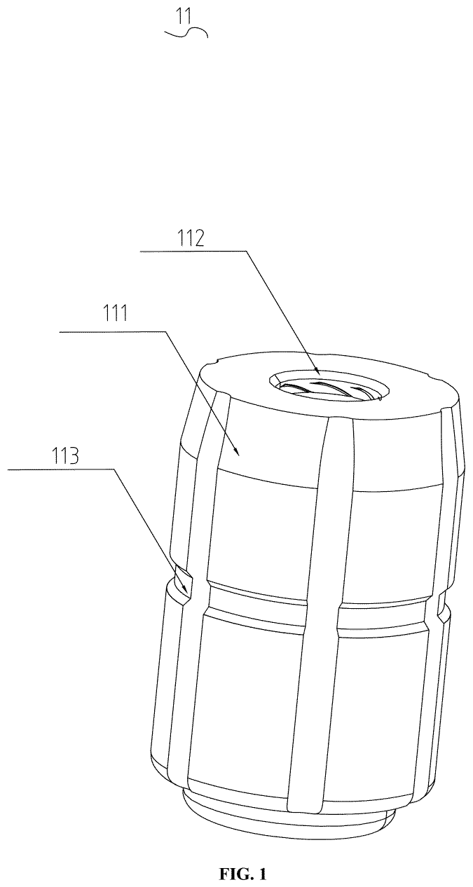

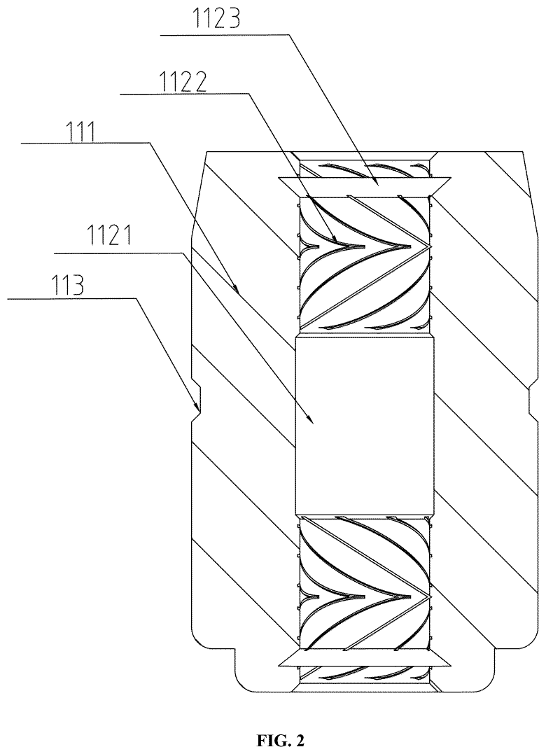

Referring to FIG. 1 and FIG. 2, the present disclosure provides a hydrodynamic bearing 11, including a bearing main body 111, a through hole 112, and a plurality of heat dissipation slots 113; the bearing main body 111 is cylindrical; the through hole 12 is provided in a center of the bearing main body 111 in a penetrating manner; an oil storage groove 1121 is arranged in a middle part of the through hole; the oil storage groove 1121 can store some of excess lubricating oil; a plurality of oil slots 1212 are provided on upper and lower sides of an inner wall of the through hole 112; and the oil slots 1212 are herringbone and accommodates lubricating oil. When a motor rotates at a high speed, a rotating shaft 12 drives the lubricating oil in the plurality of oil slots 1212 to move; the lubricating oil is converged from two side ends of the herringbone oil slots 1212 to vertexes of the herringbone oil slots; when the lubricating oil reaches the vertexes of the herringbone oil slots 1212, the lubricating oil forms high oil pressures at the vertexes; and the rotating shaft 12 is jacked by the several high oil pressures in the through hole 112, so that the rotating shaft 12 and the hydrodynamic bearing 11 rotate at a high speed in a non-contact state. Oil leak prevention slots 1213 are respectively provided on two sides, close to end openings, of the inner wall of the through hole 112; and the two oil leak prevention slots 1213 are respectively communicated with the corresponding oil slots 1212. The two oil leak prevention slots 1213 are used to prevent the lubricating oil from flowing out of the two end openings of the through hole 112. The plurality of heat dissipation slots 113 are respectively provided on an outer side of the bearing main body 111. Specifically, the heat dissipation slots include transverse heat dissipation slots and longitudinal heat dissipation slots; and the transverse heat dissipation slots and the longitudinal heat dissipation slots are respectively crosswise arranged on the outer side of the bearing main body 111. The heat dissipation slots 113 are used to enable air to pass through, to perform air cooling on the bearing main body 111. In this embodiment, the bearing main body 111 is made of copper, which is conductive to improving the machining precision of the hydrodynamic bearing 11 and facilitates the assembling of a high-speed motor.

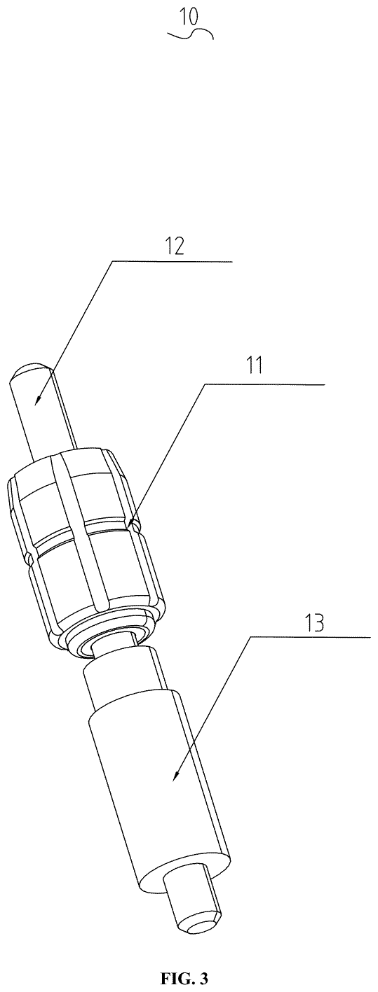

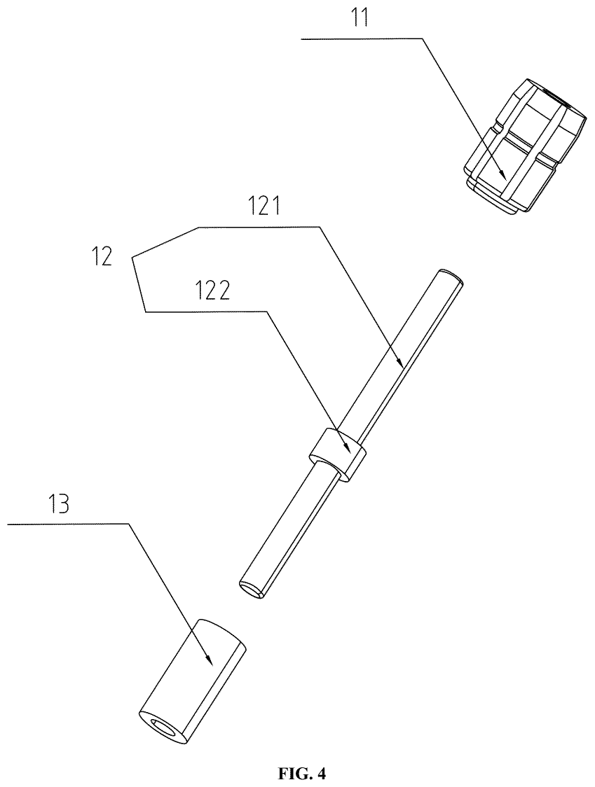

Referring to FIG. 3 and FIG. 4, a bearing assembly 10 of the present disclosure mainly includes the hydrodynamic bearing 11 according to any one of the above, a rotating shaft 12, and a magnet 13; the rotating shaft 12 is arranged on the hydrodynamic bearing 11 in a movably penetrating manner; the rotating shaft and the hydrodynamic bearing are connected in a non-contact manner through lubricating oil; the rotating shaft 12 can rotate relative to the hydrodynamic bearing 11; and the magnet 13 is fixedly arranged on the rotating shaft 12 and drives the rotating shaft 12 to rotate. In this embodiment, the rotating shaft 12 includes a rotating shaft main body 121 and a limiting column 122; the limiting column 122 is arranged at a middle part of the rotating shaft main body 121; and the rotating shaft main body 121 and the limiting column 122 are integrally formed.

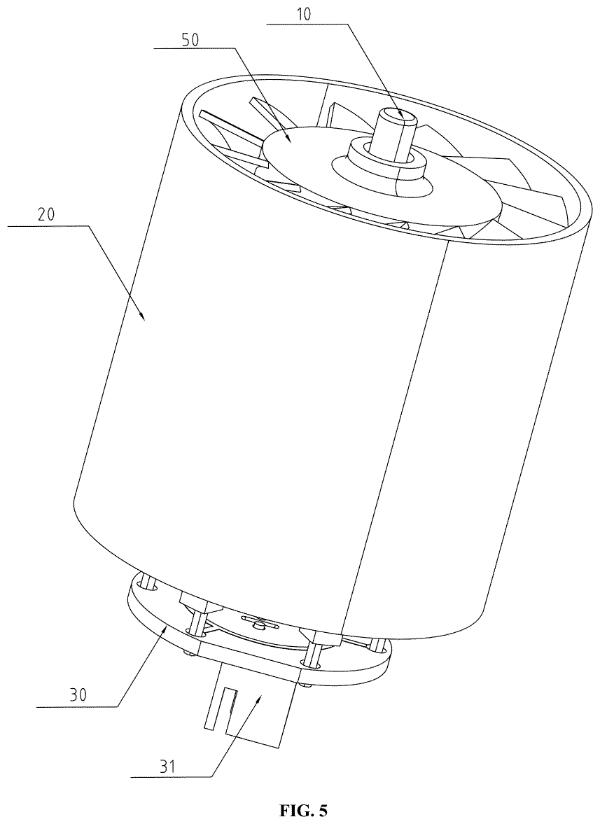

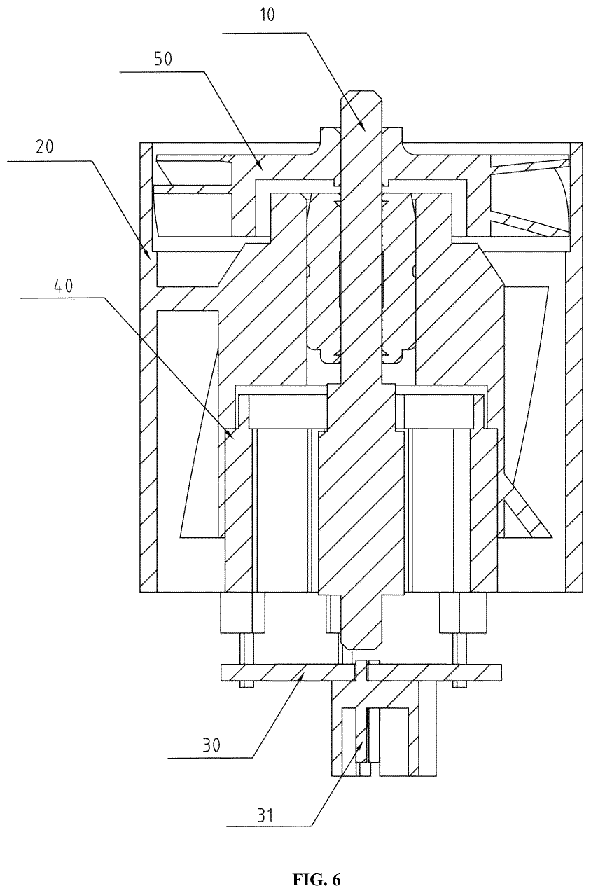

Referring to FIG. 5 and FIG. 6, a high-speed motor of the present disclosure mainly includes the bearing assembly 10 according to any one of the above, a motor shell 20, a circuit board 30, a stator assembly 40, and fan blades 50; the motor shell 20 is a hollow cylindrical chamber; and the stator assembly 40 is fixedly arranged in the motor shell 20. Specifically, the stator assembly 40 includes a stator core and a stator winding; the stator core is fixedly arranged in the motor shell 20; and the stator winding is arranged on the stator core. The circuit board 30 is fixed on one side of the stator assembly 40 and is electrically connected to the stator assembly 40; the bearing assembly 10 is arranged on the stator assembly 40 in a movably penetrating manner and can rotate relative to the stator assembly 40; and the fan blades 50 are fixedly arranged at one end of the bearing assembly 10 and rotates as the bearing assembly 10 rotates. In this embodiment, a connection interface 31 is arranged on the circuit board 30, and the connection interface 31 is electrically connected to a power supply for power supplying. Specifically, the connection interface 31 uses a connection needle seat. Contact portions between the hydrodynamic bearing 11 and an inner wall of the motor shell 20 are in interference fit, thereby ensuring the reliability of the high-speed motor and the heat dissipation performance of the hydrodynamic bearing 11. The motor shell 20 is made of a metal material. Specifically, the motor shell 20 can be made of a zinc alloy material or an aluminum alloy. In this way, the hydrodynamic bearing 11 can transfer its heat to the motor shell 20 to facilitate the heat dissipation of the hydrodynamic bearing 11.

The various technical features in the foregoing embodiments may be randomly combined. For concise description, not all possible combinations of the various technical features in the above embodiments are described. However, if combinations of these technical features do not conflict with each other, the combinations of the various technical features are considered as falling within the scope of this specification.

The foregoing embodiments merely express several implementations of the present disclosure. The descriptions thereof are relatively specific and detailed, but are not understood as limitations on the scope of the present disclosure. It should be pointed out that a person of ordinary skill in the art can also make several transformations and improvements without departing from the idea of the present disclosure. These transformations and improvements fall within the protection scope of the present disclosure. Therefore, the protection scope of the patent of the present disclosure shall be subject to the appended claims.

What is claimed is:

1. A hydrodynamic bearing, comprising a cylindrical bearing main body; and a through hole provided in a center of the bearing main body in a penetrating manner, wherein an oil storage groove is arranged in a middle part of the through hole; a plurality of oil slots are provided on upper and lower sides of an inner wall of the through hole; the oil slots are herringbone; oil leak prevention slots are respectively provided on two sides, close to end openings, of the inner wall of the through hole; and the two oil leak prevention slots are respectively communicated with the corresponding oil slots.

2. The hydrodynamic bearing according to claim 1, wherein a plurality of heat dissipation slots are provided on an outer side of the bearing main body.

3. The hydrodynamic bearing according to claim 2, wherein the heat dissipation slots comprise transverse heat dissipation slots and longitudinal heat dissipation slots; and the transverse heat dissipation slots and the longitudinal heat dissipation slots are respectively crosswise arranged on the outer side of the bearing main body.

4. The hydrodynamic bearing according to claim 2, wherein a material of the bearing main body is copper.

5. A bearing assembly, comprising the hydrodynamic bearing according to claim 1, a rotating shaft, and a magnet, wherein the rotating shaft is arranged on the hydrodynamic bearing in a movably penetrating manner; the rotating shaft and the hydrodynamic bearing are connected in a non-contact manner through lubricating oil; and the magnet is fixedly arranged on the rotating shaft and drives the rotating shaft to rotate.

6. The bearing assembly according to claim 5, wherein the rotating shaft comprises a rotating shaft main body and a limiting column; the limiting column is arranged at a middle part of the rotating shaft main body; and the rotating shaft main body and the limiting column are integrally formed.

7. A high-speed motor, comprising the bearing assembly according to claim 6, a motor shell, a circuit board, a stator assembly, and fan blades, wherein the motor shell is a hollow cylindrical chamber; the stator assembly is fixedly arranged in the motor shell; the circuit board is fixed on one side of the stator assembly and is electrically connected to the stator assembly; the bearing assembly is arranged on the stator assembly in a movably penetrating manner; and the fan blades are fixedly arranged at one end of the bearing assembly.

8. The high-speed motor according to claim 7, wherein the stator assembly comprises a stator core and a stator winding; the stator core is fixedly arranged in the motor shell; and the stator winding is arranged on the stator core.

9. The high-speed motor according to claim 7, wherein a connection interface is arranged on the circuit board, and the connection interface uses a connection needle seat.

10. The high-speed motor according to claim 7, wherein the motor shell is made of a metal material, and contact portions between the hydrodynamic bearing and an inner wall of the motor shell are in interference fit.
